(19) United States
(12) Patent Application Publication
(10) Pub. No.: US 2017/0017749 A1
(43) Pub. Date: Jan. 19, 2017

(54) SYSTEM AND METHOD FOR IDENTIFYING CANCER DRIVER GENES

(71) Applicant: International Business Machines Corporation, Armonk, NY (US)

(72) Inventors: BOAZ CARMELI, KORANIT (IL); OMER WEISSBROD, REHOVOT (IL); ZEEV WAKS, PETAH TIKVA (IL)

(21) Appl. No.: 14/799,641

(22) Filed: Jul. 15, 2015

(51) Int. Cl. G06F 19/18

(52) U.S. Cl. CPC G06F 19/18

(57) ABSTRACT

A method for identifying cancer driver genes is provided. The method includes receiving at least one patient input file containing information for a mutation variation and/or an expression of the gene, parsing the information from the input file into a data structure, annotating the information with cancer driving related annotation, extracting genetic features related to the patient from the information, and scoring the information with a first probability that the mutation variation drives cancer and/or a set of further probabilities that the expression of the gene drives cancer. The first probability and the set of further probabilities are calculated with a first and second Bayesian Network graphical model, respectively.

### BACKGROUND

The present invention generally relates to a system and method for identifying cancer driver genes, and more particularly to a system and method for identifying driver genes that promote a cancer of a specific patient.

A major goal in cancer precision medicine is to identify what genes promote a patient's cancer. Such genes are known as driver genes. Driver genes can promote cancer by either loss-of-function or gain-of-function. For example, tumor suppressor genes function to prevent cancer in healthy cells. However, if these genes experienced a loss-of-function, then cancer could be promoted (i.e., no longer suppressed). Oncogenes, on the other hand, cause cancer and a gain-of-function in these genes can result in an increased promotion of cancer. Proto-oncogenes are genes that do not cause cancer themselves, but upon a mutation become oncogenes.

Loss-of-function can occur upon gene deletion, decreased (or low) gene expression, or mutations of the inactivating type. Gain-of function can occur by gene copy gain, increased (or high) gene expression, or mutations that increase or change the activity of the gene.

After identifying a patient's driver genes, care providers can develop a personalized treatment targeting these genes. However, identifying the patient's driver genes and developing a personalized treatment plan is a manual and time consuming process, requiring weeks for the care providing team to evaluate the available information and recommend a treatment. Such difficulties in developing a treatment plan stem from the nature of the cancer disease itself. Cancer is a disease that originates from a combination of a few genomic alterations out of tens of thousands of possible combinations.

The field of cancer genomics has traditionally focused on basic research intended to identify novel cancer genes from population data. Genomic profiling for individual treatment purposes, on the other hand, is relatively new and typically relies on manual curation of information by domain experts and the creation of a table of known driver mutations. Driver gene identification is analogous to a string search for specific pre-defined mutations.

### SUMMARY

According to one embodiment of the present invention, a method for identifying cancer driver genes is provided. The method includes receiving at least one input file for a patient containing information for a mutation variation of a gene and/or an expression of the gene, parsing information from the input file into a data structure, annotating the information with cancer driving related annotations, extracting genetic features related to the patient from the information, and scoring the information with a first probability that the mutation variation drives cancer and/or a set of further probabilities that the expression of the gene drives cancer. The first probability and the set of further probabilities are calculated with a first and second Bayesian Network graphical model, respectively. The Bayesian Network graphical models utilize the genetic features related to the patient, the cancer driving related annotations, and weighted probabilities. The method further includes calculating a driver probability that the gene drives cancer, which is calculated from the first probability and the set of further probabilities.

According to another embodiment, a system for identifying cancer driver genes is provided. The system can include at least one processor, at least one computer readable memory, at least one computer readable tangible, non-transitory storage medium, and program instructions stored on the at least one computer readable tangible, non-transitory storage medium for execution by the at least one processor via the at least one computer readable memory. The program instructions include instructions for receiving an input file containing information for a mutation variation of a gene and/or an expression of the gene, parsing the information into a data structure, annotating the information with cancer driving related annotations, extracting genetic features from the information, and scoring the information with a first probability that the mutation variation drives cancer and/or a set of further probabilities that the expression of the gene drives cancer, which are calculated with a first and second Bayesian Network graphical model, respectively. The method further includes calculating a driver probability that the gene drives cancer, which is calculated from the first probability and the set of further probabilities.

According to another embodiment, a computer program product for identifying cancer driver genes is provided. The computer program product can include at least one computer readable non-transitory storage medium having computer readable program instructions for execution by a processor. The computer readable program instructions include instructions for receiving an input file containing information for a mutation variation of a gene and/or an expression of the gene, parsing the information into a data structure, annotating the information with cancer driving related annotations, extracting genetic features from the information, and scoring the information with a first probability that the mutation variation drives cancer and/or a set of further probabilities that the expression of the gene drives cancer, which are calculated with a first and second Bayesian Network graphical model, respectively. The method further includes calculating a driver probability that the gene drives cancer, which is calculated from the first probability and the set of further probabilities.

### BRIEF DESCRIPTION OF THE SEVERAL VIEWS OF THE DRAWINGS

The following detailed description, given by way of example and not intended to limit the invention solely thereto, will best be appreciated in conjunction with the accompanying drawings, in which:

FIG. 1 is a block diagram illustrating internal components of a molecular profile analysis tool, according to an aspect of the invention;

FIG. 2 is a block diagram illustrating a method for identifying cancer driver genes, according to an aspect of the invention;

FIG. 3 is a block diagram illustrating a hierarchy of molecular profile input file types for analysis by the molecular profile analysis tool, according to an aspect of the invention;

FIG. 4 is a block diagram illustrating interfaces for the molecular profile analysis tool, according to an aspect of the invention;

FIG. 5-7 are flowcharts illustrating analytic paths through the molecular profile analysis tool for various mutation input files, according to an aspect of the invention;

FIG. 8 is a block diagram illustrating gene type annotations and relationships between these gene types utilized by the molecular profile analysis tool, according to an aspect of the invention;

FIG. 9 is a block diagram illustrating a first Bayesian Network model for calculating a first probability that a mutation variation drives cancer, according to an aspect of the invention;

FIG. 10 is a block diagram illustrating the first Bayesian Network model of FIG. 9 including exemplary values, according to an aspect of the invention;

FIG. 11 is a block diagram illustrating a second Bayesian Network model for calculating a set of further probabilities that an expression of a gene drives cancer, according to an aspect of the invention;

FIG. 12 is a block diagram illustrating the second Bayesian Network model of FIG. 11 including exemplary values, according to an aspect of the invention;

FIG. 13 is a block diagram illustrating a cloud computing node, according to an aspect of the invention;

FIG. 14 depicts a cloud computing environment, according to an aspect of the invention; and

FIG. 15 depicts abstraction model layers, according to an aspect of the invention.

The drawings are not necessarily to scale. The drawings are merely schematic representations, not intended to portray specific parameters of the invention. The drawings are intended to depict only typical aspects and embodiments of the invention. In the drawings, like numbering represents like elements.

### DETAILED DESCRIPTION

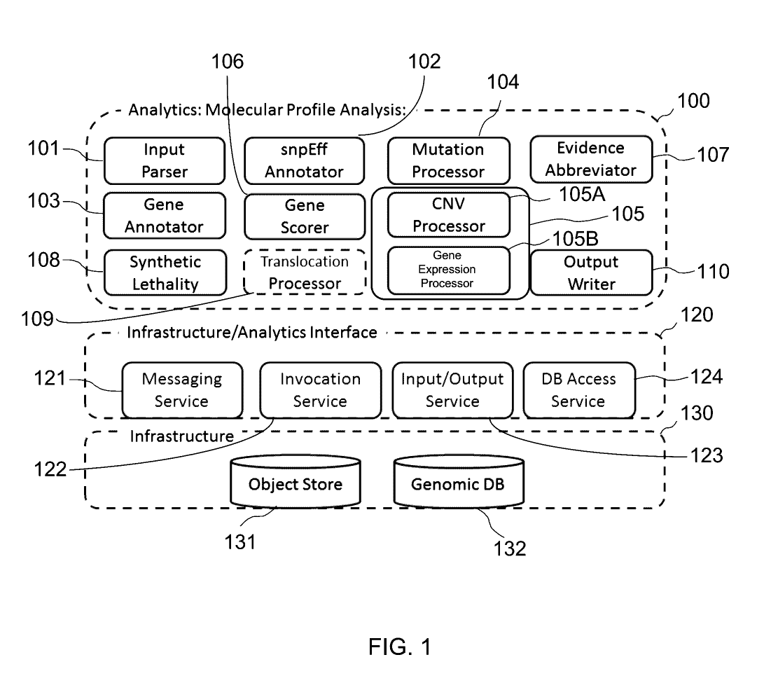

Various embodiments of the present invention will now be discussed with reference to FIGS. 1 through 17, like numerals being used for like and corresponding parts of the various drawings.

Referring to FIG. 1, in one embodiment, a molecular profile analysis tool (MPA) 100 is provided. MPA 100 is composed of various components including input parser 101, snpEff annotator 102, gene annotator 103, mutation processor 104, expression processor 105 (which includes copy number variant (CNV) processor 105A and gene expression processor 105B), gene scorer 106, evidence abbreviator 107, synthetic lethality processor 108, and output writer 110. MPA 100 can also include translocation processor 109. Infrastructure/analytic interfaces 120 for MPA 100 can include messaging service 121, invocation service 122, input/output service 123, and database access service 124. Infrastructure 130 for MPA 100 includes object store 131 and genomics database 132, which can contain extensive amounts of genetic and genomic knowledge and information pertaining to cancer in general and to driver genes in particular.

Input parser 101 parses one or more molecular profile input files for a case (i.e., a patient) into a data structure (e.g., a Java data structure) that can be handled by the rest of the MPA components. SnpEff annotator 102 and gene annotator 103 annotate the case files with mutation variation information and cancer driving related information, respectively. This is done by querying genomic database 132. Mutation processor 104 processes and scores the probability that a mutation variation in the case drives cancer. Expression processor 105 processes and scores the probability that the expression of a gene drives cancer. Gene scorer 106 combines the results from mutation processor 104 and/or expression processor 105 and calculates the probability that a gene in the case drives cancer. Evidence abbreviator 107 collects and abbreviates the case's related evidence. Synthetic lethality processor 108 identifies pairs of genes that have a functional relationship that can be targeted leading to cell death. Output writer 110 writes the results of MPA 100 analysis to output files. In one embodiment, it is contemplated that translocation processor 109 identifies, processes, and scores a probability that a translocation in a gene drives cancer. The output from translocation processor 109 can be sent to gene scorer 106 for integration into a driver probability for the gene.

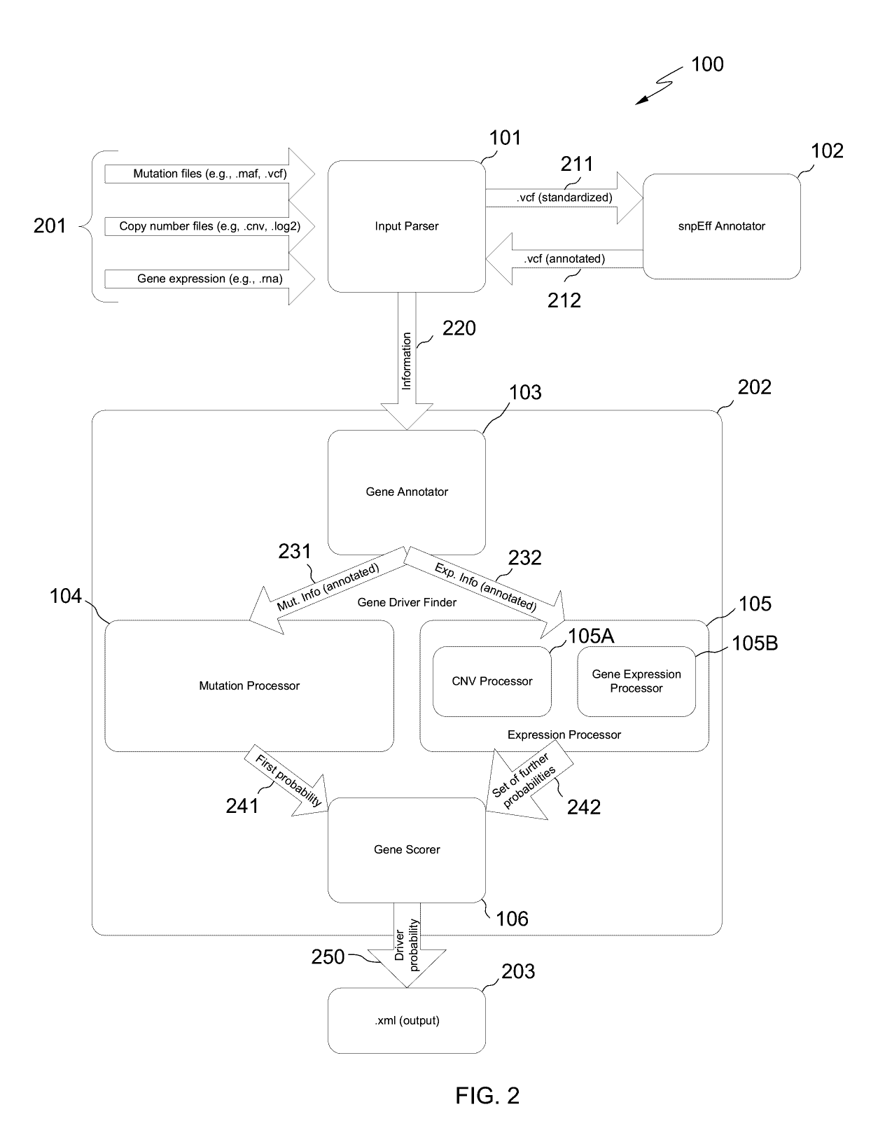

Referring to FIG. 2, in one embodiment, input parser 101 parses information from a plurality of molecular profile input files 201 into a data structure (e.g., a Java data structure) for further processing by other components of MPA 100. Molecular profile input files can include (a) mutation input format files containing mutation information for a patient's genes; (b) copy number format files containing genomic copy information of patient's genes; (c) gene expression format files containing expression information for a patient's genes and (d) any other case specific format file with molecular variant information, e.g., translocation, methylation, etc. (not shown). In the embodiment depicted in FIG. 2, after being parsed from the plurality of molecular profile input files 201, information 220 is provided to gene driver finder 202, where it is first annotated by gene annotator 103 with annotations that facilitate gene classification. After information 220 has been annotated, the information is then processed by one or more processors (e.g., mutation processor 104 and/or expression processor 105). In this embodiment, information 220 contains mutation information and expression information. Annotated mutation information 231 is processed by mutation processor 104, which calculates a first probability 241 that a particular mutation variation drives the patient's cancer. Annotated expression information 232 is processed by expression processor 105, which calculates a set of further probabilities 242 that an expression of a gene drives a patient's cancer. Gene scorer 106 calculates a driver probability 250 that the gene drives cancer, which is calculated from the first probability 241 and/or the set of further probabilities 242, and outputs the results to an output file 203 (e.g., an .xml file). It is understood that the terms “a first probability” and “a set of further probabilities” refer to separately calculated values and do not imply a sequencing order or preference for a first value over subsequent values. It is also understood that gene scorer 106 can calculate the driver probability 250 from (a) the first probability 241 alone; (b) the set of further probabilities 242 alone; or (c) both the first probability 241 and the set of further probabilities 242. Beyond mutation variation information and gene expression information, it is contemplated that MPA 100 may identify, process, and score a probability that any other molecular marker for a gene variant (e.g., translocation, methylation) drives cancer. Such probability can be sent to gene scorer 106 for integration into the driver probability 250 for the gene.

The mutation input format files can be provided, for example, in two types of formats: mutation annotation format (MAF) and variant call format (VCF). MAF files should be provided as .maf files. MAF files can include the following categories of data for somatic mutations: mis sense and nonsense, splice sites (defined as single nucleotide polymorphisms (SNP) within two base pairs of the splice junction), silent mutations, indels that overlap the coding region or splice site of a gene (or the targeted region of a genetic element of interest), frameshift mutations, and mutations in regulatory regions. VCF files should be provided as .vcf files. VCF files can include genetic information for variations along with a reference genome. It is understood that mutation input format files can contain information for multiple genes and/or multiple mutation variations. It is also understood that a gene can have multiple mutation variations.

The copy number format files can be provided, for example, in two types of formats: copy number variant (CNV) and log2 formats. CNV files should be provided as .cnv files. CNV files can include the absolute number of copies of a particular gene on a chromosome. Log2 files should be provided as .log2 files. Log2 files can include the result of taking the log2 ratio of the normalized copy number value of a sample compared to a reference. Thus, the log2 value is calculated with Equation 1, below:

$${Log}_{2} Value = {Log}_{2} ( \frac{{Signal}_{tumor}}{{Signal}_{reference}} ) \qquad Equation 1$$

Exemplary estimated copy number values from the log2 ratio are provided in Table 1, below:

TABLE 1

| Copy number | Log₂ value |
|---|---|
| 0 copies | log₂Val = −Infinity = log₂(0/2) |
| 1 copy (LOH) | log₂Val = −1 = log₂(1/2) |
| 2 copies (normal) | log₂Val = 0 = log₂(2/2) |
| 3 copies | log₂Val = 0.58 = log₂(3/2) |
| 4 copies | log₂Val = 1 = log₂(4/2) |
| 5 copies | log₂Val = 1.32 = log₂(5/2) |

However, estimating the copy number from the log2 ratio is not limited to the above example and can include additional complexity. MPA 100 annotates genes as CNV gain, loss, or none. A gene with a log2 value >1 is considered a CNV “gain.” Likewise, genes with a log2 ratio in the top 2% of all genes are also considered CNV gains. For CNV “loss,” a gene must have a log2 value <−0.5 or should have a log2 ratio in the bottom 2% of all genes. Genes that do not fit the above criteria are considered CNV “none.”

Gene expression format files can be provided, for example, before or after the expression levels for the genes have been normalized. Gene expression format files can be provided with the following non-limiting example suffixes .dge, .drna, .dmrna, .age, .rna, and .mrna. It is well established that certain genes can promote oncogenesis when they are highly expressed. Likewise, tumor suppressor genes can drive cancer when they have low expression. In a preferred embodiment, the gene expression format file is provided after expression levels for the genes have been normalized.

In one embodiment, the RNA levels from tumor samples should be normalized against a reference sample to determine under or over expression, which is typically referred to as differential expression analysis. Differential expression analysis can be in the form of normalizing to adjacent healthy tissue, normalizing to non-adjacent normal tissue (such as blood), or normalizing to population samples of health tissue. In another embodiment, normalization is done against tumor samples of the same kind.

A summary of non-limiting, exemplary input files is provided below in Table 2.

TABLE 2

| Extension | Type | Detailed Content Type | Units |
|---|---|---|---|
| .maf | Mutation | Based on the MAF standard | N/A |
| .vcf | Mutation | Based on the VCF standard | N/A |
| .cnv | Copy Number | Absolute copy number values | cnv |
| .log2 | Copy Number | Log 2 ratio of copy number | log2ratio |
| | | values | |
| .cat6 | Copy Number | Values between 0 and 5 | cat6 |
| .age | Gene Expression | Absolute gene expression | reads |
| .nge | Gene Expression | Absolute normalized | reads |
| | | expression | |
| .dge | Gene Expression | Differential gene expression | fold2 |
| .zge | Gene Expression | Standardized differential | zscore |
| | | expression | |

The .cnv file can include absolute reads in contrast to the log2 ratio. The .cath file can include the following values: Moss of two copies; 1=loss of one copy; 2=normal; 3=mild gain; 4=gain; and 5=high gain. The .age file can include a list of genes along with their absolute expression values. The .nge file can include an absolute normalized transcript value, which is the percentage of a given mRNA out of the entire RNA content. The .dge file may be in units that are fold numbers against a reference. 2-fold over expression means that the tumor had two times the number of a given mRNA than a reference sample. The .zge file may be a processed format that contains z-scores, which can be a differential measure of expression, measured in standard deviations from the mean.

In another embodiment, the input files are assessed for quality. For example, an input quality assessment module (not shown) may be provided, which can provide an estimated score for the input quality of the files. MPA 100 may refrain from continuing the analysis of files with input quality assessment scores below a configurable threshold. The input quality assessment score can be provided as a ratio between the failed and total number of lines within each of the input files. If the input quality assessment score is zero (i.e., no lines can be successfully parsed from the input file), input parser 101 may not parse the file and MPA 100 stops analysis of the file.

In another embodiment, during the parsing process, input parser 101 collects and reports on various problems in the input file, such as (a) problems that prevent input parser 101 from parsing specific variants, which are reported as errors and the variants are ignored; or (b) problems that allow input parser 101 to continue to parse the variant, which are reported as warnings.

In one embodiment, input parser 101 receives mutation input format files (e.g., .maf or .vcf files) and/or copy number format files (e.g., .cnv files) and/or gene expression files (e.g., .rna files), and parses the information from these files into a Java data structure that can be handled by the rest of the components in MPA 100.

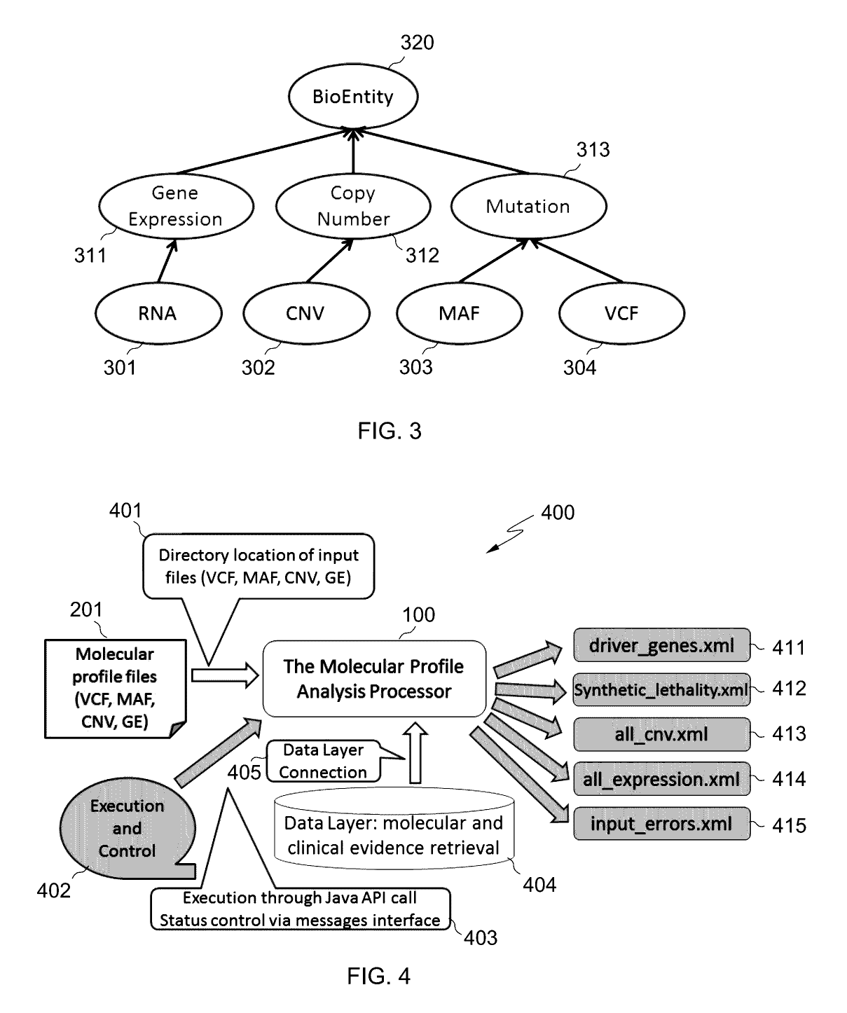

FIG. 3 represents an exemplary hierarchy for molecular profile input files. RNA file 301 provides gene expression information 311. CNV file 302 provides copy number variant information 312, MAF file 303 and VCF file 304 provide mutation variation information 313. Gene expression information 311, copy number variant information 312, and mutation variation information 313 comprise the molecular profile information 320 for the bioentity (e.g., the patient).

FIG. 4 depicts system 400, which includes MPA 100 and various interfaces. Molecular profile input files 201 are provided to MPA 100 from directory location(s) 401. Execution and control module 402 provides execution through Java API call and status control via a message interface (see 403). Molecular and clinical evidence in data layer 404 is provided to MPA 100 via data layer connection 405. In one embodiment, genomic database 132 (see FIG. 1) holds the molecular and clinical evidence in data layer 404. MPA 100 writes various output files (e.g., driver_genes.xml 411, synthetic_lethality.xml 412, all_cnv.xml 413, all_expression.xml 414, input_errors.xml 415) to directory location(s).

Driver gene output file (e.g., driver_genes.xml 411) holds information about driver genes and supporting rationale. Synthetic lethality output file (e.g., synthetic_lethality.xml 412) holds results of a synthetic lethality analysis. All CNV output file (e.g., all_cnv.xml 413) holds CNV levels for all existing genes in the input .cnv file (if provided), e.g., after Loge analysis that is done by the MPA. All expression output file (e.g., all_expression.xml 414) holds gene expression levels for all existing genes in the input gene expression file (if provided), e.g., after deferential expression analysis that is done by the MPA. Input error output file (e.g., input_error.xml 415) holds results of an input quality assessment (including input quality scores, errors, and/or warnings).

In one embodiment, multiple molecular profile input files of the same type may be provided (e.g., multiple .maf files).

MPA 100 is able to generate a driver gene output file (e.g., driver_genes.xml 411) and a synthetic lethality output file (e.g., synthetic_lethal.xml 412) for any, non-empty, input file combination.

MPA 100 can analyze input files as a synchronous or asynchronous process. In one embodiment, analysis starts upon a Java execute request from an AV node. Upon execution completion, MPA 100 writes its output files to an output location (e.g., directory) and returns an execution status to the AV node. While processing, MPA 100 can report its status to the AV node via messages over a message control interface.

Mutation input format files can be provided with annotations regarding a mutation variation including variation characteristics and a predicted effect that such a mutation variation will have on the gene. However, in some embodiments, mutation input format files are provided without such annotations. In such embodiments, snpEff annotator 102 can annotate the mutation input format file. SnpEff annotator 102 can provide annotation and complementary information on gene mutations. MPA 100 activates snpEff annotator 102 as a standalone Java process. SnpEff annotator 102 requires a VCF input file. If the mutation input format file is an MAF file, MPA 100 translates the MAF file into a VCF file. SnpEff annotator 102 creates a new VCF file containing all the information in the originally received VCF file and its variant annotations.

Referring back to FIG. 2, input parser 101 receives molecular profile input files 201, which may include a .vcf file without annotation. Input parser 101 can process the non-annotated .vcf file into a standardized .vcf file 211 (lacking annotation), which is sent to snpEff annotator 102, which annotates the standardized .vcf file 211 and returns to input parser 101 an annotated .vcf file 212.

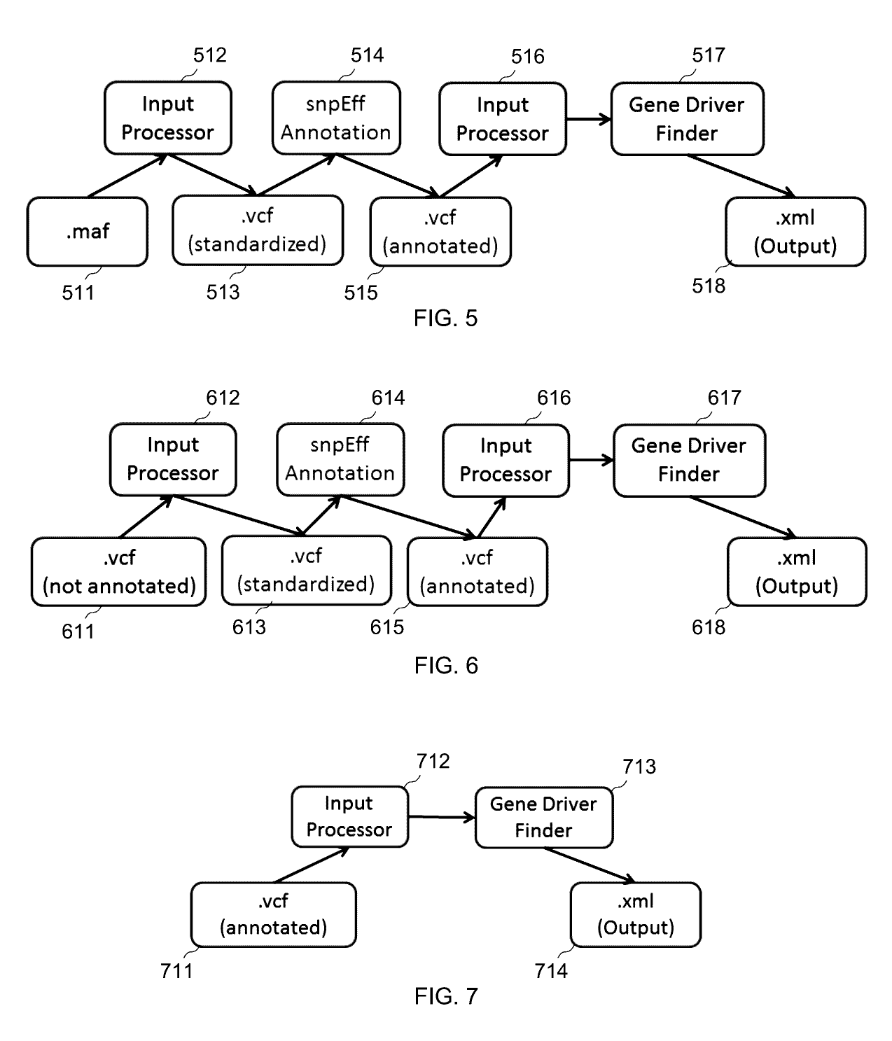

FIGS. 5-7 illustrate various data flows for various mutation input format files. FIG. 5 illustrates a flowchart for when the mutation input format file is an MAF file (i.e., .maf file 511). At 512, an input processor receives, processes, and translates .maf file 511 and returns a standardized .vcf file 513. At 514, the snpEff annotator receives and annotates the received standardized .vcf file 513 and returns an annotated .vcf file 515. At 516, the input processor receives and processes annotated .vcf file 515 and sends information to gene driver finder 517, which processes the information and outputs output file 518.

FIG. 6 illustrates a flowchart for when the mutation input format file is a VCF file without annotation (i.e., non-annotated .vcf file 611). At 612, an input processor receives and processes non-annotated .vcf file 611 and returns a standardized .vcf file 613. At 614, the snpEff annotator receives and annotates the received standardized .vcf file 613 and returns an annotated .vcf file 615. At 616, the input processor receives and processes annotated .vcf file 615 and sends information to gene driver finder 617, which processes the information and outputs output file 618.

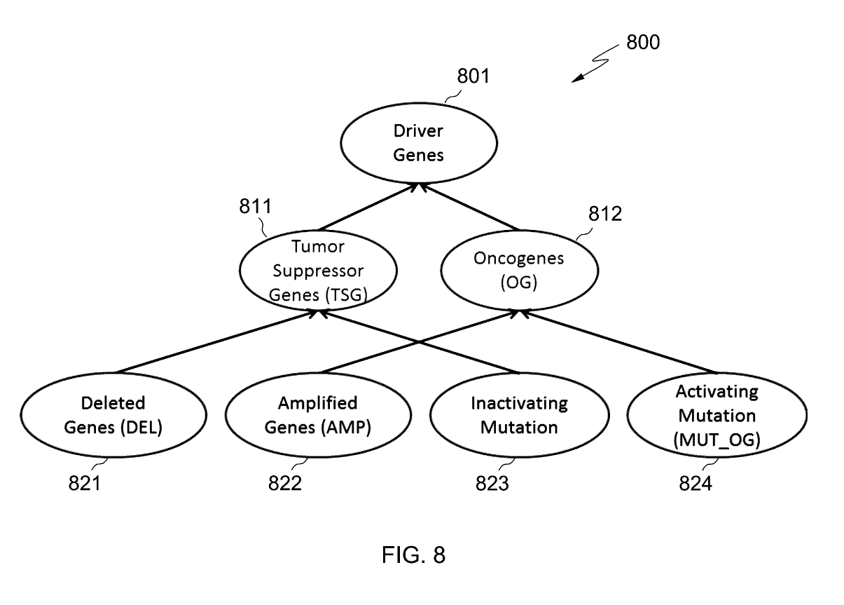

FIG. 7 illustrates a flowchart for when the mutation input format file is an annotated VCF file (i.e., annotated .vcf file 711). At 712, an input processor receives and processes annotated .vcf file 711 and sends information to gene driver finder 713, which processes the information and outputs output file 714. In some embodiments, the input processor referred to in FIGS. 5-7 is input parser 101.

Referring back to FIG. 2, gene annotator 103 annotates information 220 with cancer driving related annotations that facilitate gene classification, such as by identifying the subclasses for the gene being analyzed. For example, oncogene classification is useful in determining the functional impact of overexpressed or amplified genes, and especially so in the case of amplification activated oncogenes (and less so in the case of mutation activated oncogenes). Conversely, tumor suppressor gene classification suggests that gene deletion or inactivation via mutation may cause a functional impact on the gene.

MPA 100 integrates existing knowledge from multiple sources to generate ranked lists of annotated cancer genes. Table 3, below, lists exemplary cancer driving related annotations:

TABLE 3

| Label | Description |
|---|---|
| MUT | Frequently mutated cancer gene |
| AMP | Driver gene due to amplification |
| DEL | Driver gene due to deletion |
| OG | Oncogene |
| TSG | Tumor suppressor gene |
| MUT_OG | Mutation activated oncogene |

The above exemplary set of cancer driving related annotations obeys an internal hierarchy, which is illustrated in FIG. 8. FIG. 8 illustrates gene hierarchy 800 for driver genes 801, tumor suppressor genes (TSGs) 811, oncogenes (OGs) 812, deleted genes (DEL) 821, amplification activated genes 822, inactivating mutations 823, and mutation activated genes 824.

The annotation of each gene and the probability for each of the annotations can be calculated in advance and saved within a genomic database. The annotation and probabilities are calculated from a variety of data sources including Vogelstein et al., Science 2013, Lawrence et al., Nature 2014, FoundationOne, COSMIC_CGC, COSMIC, CLINVAR, among other sources. Mutation processor 104 uses the gene classification when assessing the first probability that the mutation variation drives cancer.

It is contemplated that machine learning approaches can be used to understand the functional importance of gene amplification and/or overexpression in various cases, e.g., in the case of mutation activated oncogenes. These approaches can then be used to learn the statistical probability distribution of each and every gene classification annotation.

In one exemplary embodiment, gene annotator 103 uses Vogelstein 2020 rule, which classifies TSGs and OGs. According to this rule, when over 20% of mutations in a cancer-related gene are missense and clustered at recurrent positions in the gene (i.e., same amino acids), the gene is classified as an OG. When over 20% of mutations in a gene are inactivating, the gene is classified as a TSG. In contradicting cases, where a gene has an OG score of over 20% and a TSG score of over 5%, the gene is classified as a TSG. In other embodiments, other approaches and/or rules can be used to classify TSGs and OGs.

Gene annotator 103 integrates annotations from various sources and provides a single probability value for each gene annotation, which is calculated with Equation 2, below:

$$IntegratedAnnotation = \frac{{\sum }_{n}^{N} {Credibility}_{source\_n} * {LabelConfidence}_{source\_n}}{\begin{matrix}{\sum }_{n}^{N} {Credibility}_{source\_n} * \\ max ( label\_confididenc \_for \_source \_n )\end{matrix}} \qquad Equation 2$$

Referring back to FIG. 2, mutation processor 104 receives annotated mutation information 231 and provides, for each mutation variation, a first probability that the mutation variation drives cancer. Mutation processor 104 calculates a feature vector for each mutation variation, and then uses the feature vector together with the gene annotations to calculate the importance of each mutation variation in driving the cancer process.

Exemplary Bayesian Networks graphical models utilized by the present invention will now be described. The Bayesian Network graphical models described herein are capable of learning the weighted probabilities related to driver genes after analyzing vast amount of patient information along with the insights and decisions made by expert physicians.

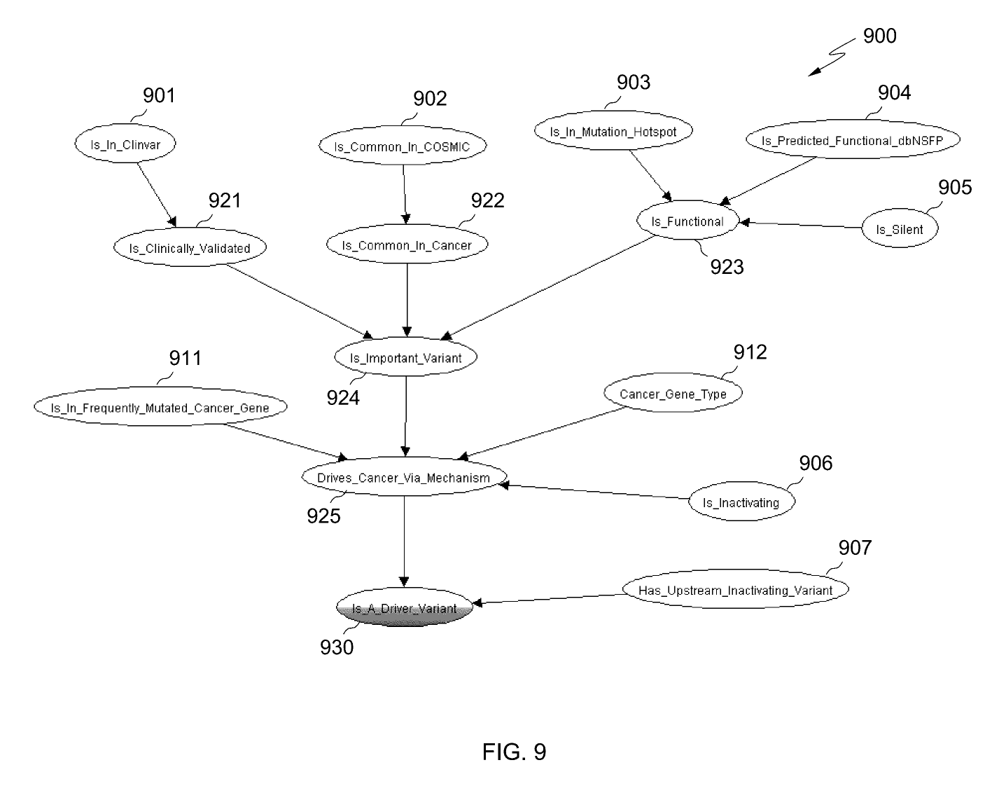

Referring to FIG. 9, a first Bayesian Network graphical model 900 will now be described. In one embodiment, the first Bayesian Network graphical model 900 is used to calculate a first probability 930 that a mutation variation drives cancer. The first Bayesian Network graphical model 900 comprises three sets of nodes: a first set of nodes listing genetic features related to the patient (901-907); a second set of nodes listing cancer driving related annotations (911, 912); and a third set of nodes listing weighted probabilities (921-925) utilized by the first Bayesian Network graphical model 900 (i.e., a first set of weighted probabilities). Also, at least one of the weighted probabilities in the first set of weighted probabilities relates to at least one of the genetic features related to the patient. See, e.g., nodes 921 and 901. At least one of the weighted probabilities in the first set of weighted probabilities relates to at least one of the cancer driving related annotations. See, e.g., nodes 925 and 911. The first probability 930 that the mutation variation drives cancer relates to at least one of the weighted probabilities in the first set of weighted probabilities (e.g., node 925) and at least one of the genetic features related to the patient (e.g., node 907).

In one embodiment, mutation processor 104 extracts from the annotated mutation information 231 (and calculates from various data sources) genetic features related to the patient. In one embodiment, mutation processor 104 generates three types of mutation features: (1) known events, i.e., events that have been clinically validated to drive cancer; (2) common cancer events, i.e., events that are frequently observed in cancer patients; and (3) predicted events, i.e., events that are predicted by various means to drive cancer.

With continuing reference to FIG. 9, in one embodiment, the first set of nodes listing genetic features related to the patient includes at least one of a determination 901 of whether the mutation variation is clinically important (a rule-based decision using the NCBI ClinVar database), a determination 902 of whether the mutation variation is frequent in cancer (a rule-based assessment using the COSMIC database), a determination 903 of whether the mutation variation resides in a region of the gene that is commonly mutated in cancer, a determination 904 of whether the mutation variation is predicted to be functional, a determination 905 of whether the mutation variation is a silent mutation (utilizing an snpEff annotation), a determination 906 of whether the mutation variation is an inactivating mutation (utilizing an snpEff annotation), and a determination 907 of whether the mutation variation has an upstream inactivating mutation. In other embodiments, the first set of nodes includes two or more of the above determinations. In yet another embodiment, the first set of nodes comprises determinations 901-907. A determination that a mutation variation resides in a region that is commonly mutated in cancer genes can serve as a predictor of function importance. A determination 904 of whether the mutation variation is predicted to be functional may be predicted by algorithms such as dbNSFP (which is an ensemble of SIFT and Polyphen2, among other tools).

In one embodiment, the second set of nodes listing cancer driving related annotations includes at least one of a determination 911 of whether the gene is a frequently mutated cancer gene and a determination 912 of the cancer gene type. In another embodiment, the second set of nodes comprises determinations 911 and 912. In yet another embodiment, the second set of nodes can further include a determination of whether the gene is a driver gene due to amplification, a determination of whether the gene is a driver gene due to deletion, a determination of whether the gene is an oncogene, a determination of whether the gene is a tumor suppressor gene, a determination of whether the gene is a mutation activated oncogene, and/or a determination of whether the gene is not classified.

In one embodiment, the third set of nodes listing the first set of weighted probabilities includes at least one of a weighted probability 921 that the mutation is clinically validated, a weighted probability 922 that the mutation is frequent in cancer, a weighted probability 923 that the mutation is functional, a weighted probability 924 that the mutation is important, and a weighted probability 925 the gene drives cancer via particular mechanism. In other embodiments, the third set of nodes includes two or more of the above weighted probabilities. In yet another embodiment, the third set of nodes comprises weighted probabilities 921-925.

In one Bayesian Network graphical model embodiment, nodes 901 and 902 relate to (i.e., by providing inputs to) nodes 921 and 922, respectively. Nodes 903-905 provide inputs to node 923. Nodes 921-923 provide inputs to node 924. Nodes 906, 911, 912, and 924 provide inputs to node 925. Nodes 907 and 925 provide inputs to output node 930.

The first set of weighted probabilities (921-925) are provided by domain experts for the different combinations of inputs to each respective node (921-925). Domain experts can include an expert in the field or a panel of experts who decide upon the weights. It is contemplated that the weights may be determined by the data itself. For example, machine learning can be deployed on large sets of data to determine the appropriate weights for the different combinations of inputs to each node 921-925. The weighted probabilities of the first set of weighted probabilities (i.e., the probabilities listed in nodes 921-925) can be learnt, e.g., using machine learning and other statistical approaches by analyzing vast amount of a patient's ‘omic’ variant information along with insights from cancer genomic experts and/or information from clinical trials and/or information from treatment decisions that oncologists made along with the actual treatment success indicators.

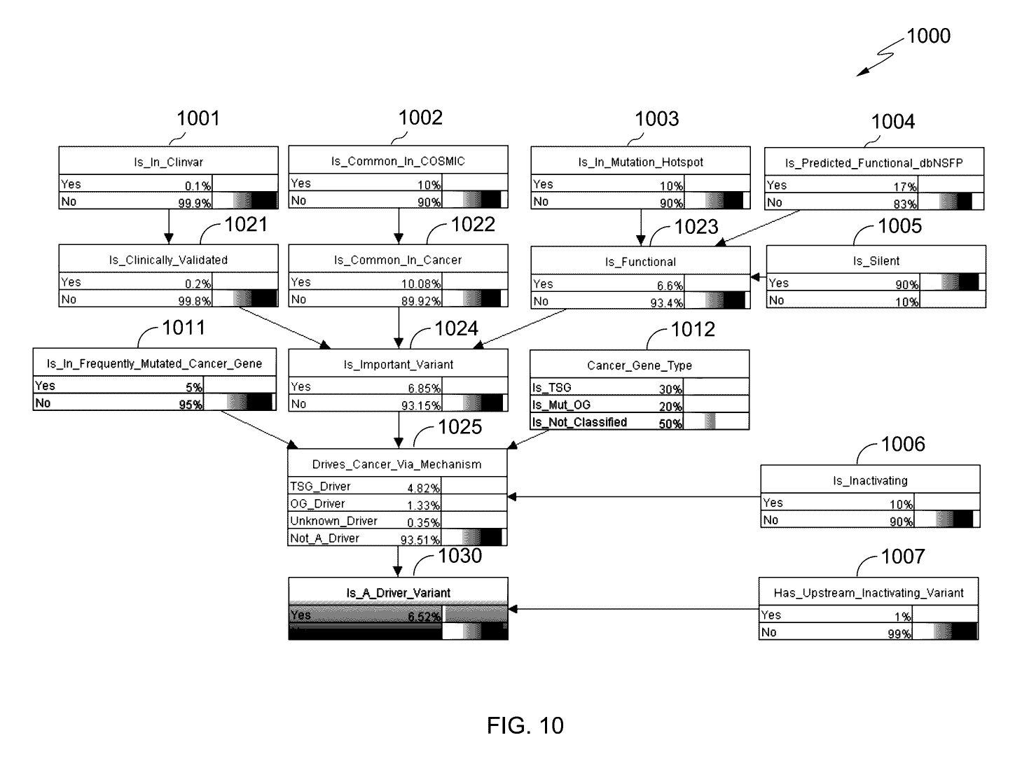

Referring to FIG. 10, an exemplary first Bayesian Network graphical model 1000 with exemplary values is provided. A first set of nodes 1001-1007 correspond to nodes 901-907 in FIG. 9, respectively. A second set of nodes 1011, 1012 correspond to nodes 911, 912 in FIG. 9, respectively. A third set of nodes 1021-1025 correspond to nodes 921-925 in FIG. 9, respectively. Output node 1030 corresponds to output node 930 in FIG. 9. In this exemplary embodiment, the cancer gene types listed in node 1012 are a determination of whether the gene is a tumor suppressor gene, a determination of whether the gene is a mutation activated oncogene, and a determination of whether the gene is not classified. Also in this exemplary embodiment, node 1025 includes weighted probabilities that the gene drives cancer as a TSG, as an OG, or as an unknown driver, or a weighted probability that the gene does not drive cancer.

Referring back to FIG. 2, expression processor 105 receives annotated expression information 232 and provides, for each gene, a set of further probabilities that the expression of the gene drives cancer. It is well established that certain genes can become oncogenic upon an increase in the amount of genomic copies, a phenomenon known as amplification. Similarly, the same genes can drive cancer as a result of increased expression that does not necessarily originate from gene duplication. Tumor suppressor genes can drive cancer if their expression is reduced, either by genomic loss or another mechanism.

mRNA levels and gene copy number are both correlates for protein abundance. MPA 100 utilizes whichever available source of information for estimating protein expression levels. MPA 100 uses adaptive reasoning logic, implemented via a Bayesian Network, in order to combine all available expression knowledge and patient data into a set of further probabilities that the expression of a gene drives cancer.

Referring back to FIG. 2, expression processor 105 may include CNV processor 105A and gene expression processor 105B. CNV processor 105A receives copy number variations (from measured and calculated copy number information included in annotated expression information 232) as its input and provides drive copy number probability scores for each CNV as its output. The calculated copy number probability scores are passed to the expression processor 105 for further integration and scoring.

Gene expression processor 105B receives gene expression values (from measured and calculated expression information included in annotated expression information 232) as its input and provides driver expression probability scores for each gene as its output. The calculated expression scores are passed to the expression processor 105 for further integration and scoring.

Expression processor 105 calculates a set of further probabilities that the expression of a gene drives cancer by computing a posterior probability of being a driver variation using a second Bayesian Network model. Expression processor 105 uses the results of the CNV processor 105A and/or the results of the gene expression processor 105B to calculate the set of further probabilities, which is passed onto gene scorer 106 for final integration and scoring.

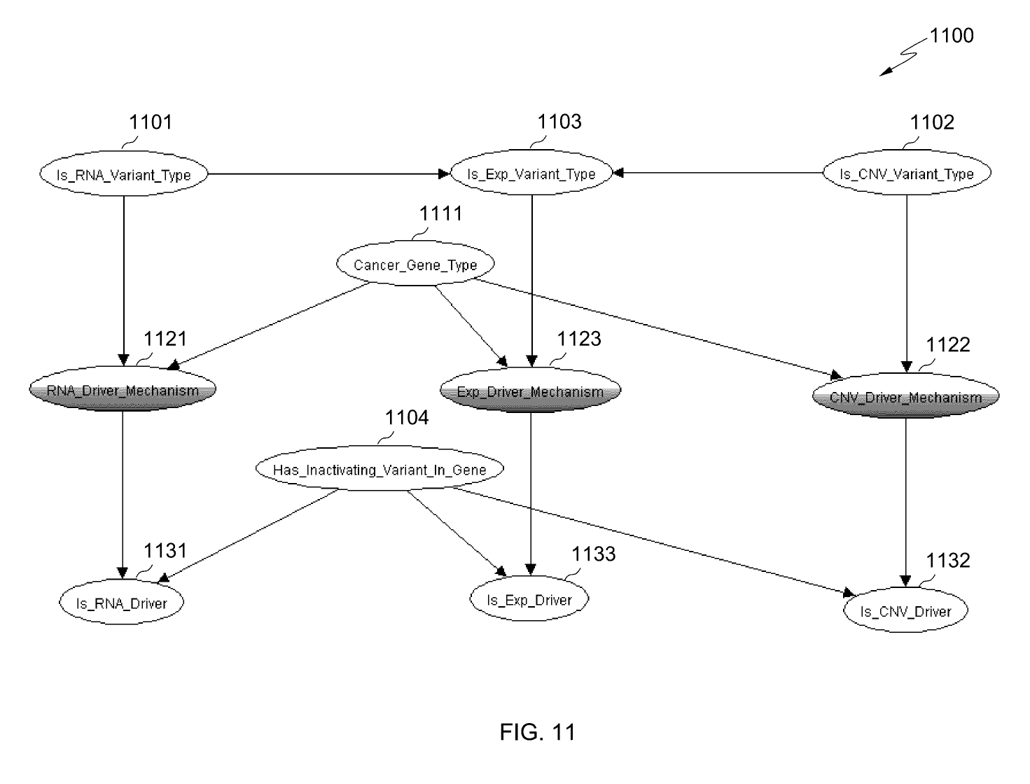

Referring to FIG. 11, a second Bayesian Network graphical model 1100 will now be described. In one embodiment, the second Bayesian Network graphical model 1100 is used to calculate a set of further probabilities that the expression of the gene drives cancer (1131-1133). The second Bayesian Network graphical model 1100 comprises three sets of nodes: a first set of nodes listing genetic features related to the patient (1101-1104); a second set of nodes listing cancer driving related annotations (1111); and a third set of nodes listing weighted probabilities (1121-1123) utilized by the second Bayesian Network graphical model 1100 (i.e., a second set of weighted probabilities). Also, at least one of the weighted probabilities in the second set of weight probabilities relates to at least one of the genetic features related to the patient. See, e.g., nodes 1121 and 1101. At least one of the weighted probabilities in the second set of weighted probabilities relates to at least one of the cancer driving related annotations. See, e.g., nodes 1121 and 1111. The set of further probabilities (1131-1133) that the expression of the gene drives cancer relates to at least one of the weighted probabilities in the second set of weighted probabilities (e.g., node 1221) and at least one of the genetic features related to the patient (e.g., node 1204).

In one embodiment, expression processor 105 considers various factors including, e.g., the type of gene and whether there is an inactivating mutation in the gene. For example, if an inactivating mutation is present in the gene, then translation from the genome to RNA will not happen because, e.g., a mutation prevents it. Thus, numerous copies of such a gene will not be important because translation will not occur.

With continuing reference to FIG. 11, in one embodiment, the first set of nodes listing genetic features related to the patient includes at least one of a determination 1101 of a level of the expression of the gene relative to a first reference gene and a determination 1102 of a level of genomic copies of the gene relative to a second reference gene. In other embodiments, the first set of nodes comprises determinations 1101 and 1102. In another embodiment, the first set of nodes listing genetic features related to the patient further includes a combined level of expression 1103 of the gene, which is calculated from the first determination 1101 and the second determination 1102. In another embodiment, the first set of nodes listing genetic features related to the patient further includes a determination 1104 of whether the gene has an inactivating mutation.

In one embodiment, the second set of nodes listing cancer driving related annotation includes a determination 1111 of cancer gene type. In another embodiment, the second set of nodes includes at least one of a determination of whether the gene is a driver gene due to amplification, a determination of whether the gene is an oncogene, a determination of whether the gene is a tumor suppressor gene, a determination of whether the gene is mutation activated oncogene, and a determination of whether the gene is not classified.

In one embodiment, the third set of nodes listing the second set of weighted probabilities includes at least one of a weighted probability 1121 that the expression of a gene drives cancer via particular mechanism, a weighted probability 1122 that the level of genomic copies drives cancer via a particular mechanism, and a weighted probability 1123 that the combined level of expression of the gene drives cancer via a particular mechanism.

Nodes 1101-1103 relate to (i.e., by providing inputs to) nodes 1121-1123, respectively. Node 1111 provides further input to nodes 1121-1123. Nodes 1121-1123 provide inputs to nodes 1131-1133, respectively. Node 1104 provides further input to nodes 1131-1133.

Similar to the first set of weighted probabilities discussed above, the second set of weighted probabilities (1121-1123) are provided by domain experts, which can include an expert in the field or a panel of experts. It is also contemplated that the weights may be determined by the data itself, for example, through machine learning deployed on large sets of data. To be clear, the Bayesian Network graphical models allow for expert knowledge to be augmented and adjusted by continually learning from a continually growing database of information and/or data.

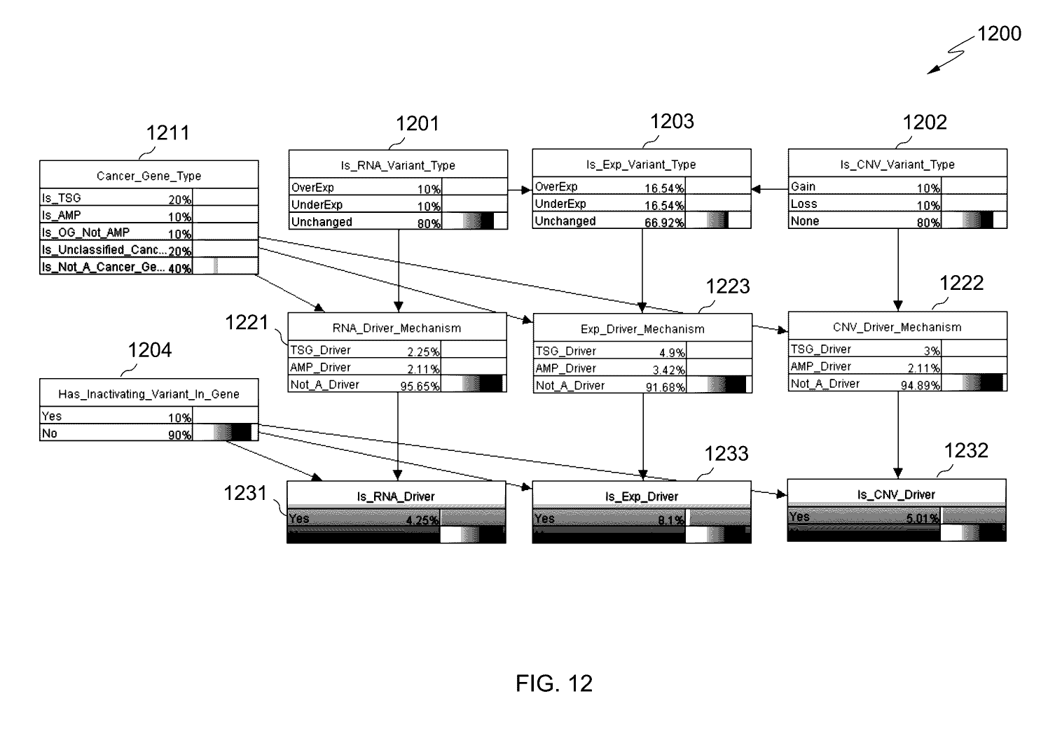

Referring to FIG. 12, an exemplary second Bayesian Network graphical model 1200 with exemplary values is provided. A first set of nodes 1201-1204 correspond to nodes 1101-1104 in FIG. 11, respectively. A second set of nodes 1211 corresponds to node 1111 in FIG. 11. A third set of nodes 1221-1223 correspond to nodes 1121-1123, respectively. Output nodes 1231-1233 correspond to output nodes 1131-1133 in FIG. 11, respectively.

Both Bayesian Network models require lists of cancer genes, which were generated from various data sources by curating several databases and scientific papers. Each gene received a score depending on how many sources it existed in, and how high it was ranked within the source (if the source was a ranked list).

Referring back to FIG. 2, gene scorer 106 calculates a driver probability 250 that a gene drives cancer, which is calculated from the first probability 241 that the mutation variation drives cancer and/or a set of further probabilities 242 that the expression of the gene drives cancer. Gene scorer 106 calculates a driver probability score for each gene in a case. Gene scorer 106 integrates all variant scores in a single driver gene score using the following formula:

Let V1 l . . . n be an array of variant scores from variant 1 to variant n.

score=0;

for i=1:n

score=score+(1−score)*Vi;

end

It will be understood that sets of nodes referenced herein may include one or more nodes.

In one embodiment, MPA 100 outputs a ranked list of cancer driver genes. In another embodiment, the output result is a ranked list of evidence-supported driver genes, including supporting rationale and additional justification (e.g., details regarding each internal calculation and probability score). The output result can be a concise, structured file (e.g., .xml file) that can be further processed without the need of the original molecular profile input files.

The method according to the invention calculates a single cancer driver probability score for each gene, which may account for driver probabilities associated with multiple variants of the gene. The method encompasses analyzing input files containing information for multiple genes, determining a single driver probability score for each gene, and outputting a ranked list of evidence-supported cancer driver genes.

Referring back to FIG. 2, in one embodiment, evidence abbreviator 107 provides supporting rationale and additional justification for each of the calculated probabilities scores. Evidence abbreviator 107 provides information about the various data sources and tools that MPA 100 uses for calculating the driver probability score (e.g., driver probability 250 that the gene drives cancer, see FIG. 2). Evidence abbreviator 107 may provide these explanations with the <justification> tag of the .xml output file(s).

Referring back to FIGS. 2 and 4, in one embodiment, output writer 110 writes all MPA results (e.g., driver_genes.xml 411, synthetic_lethality.xml 412, all_cnv.xml 413, all_expression.xml 414, input_errors.xml 415) to the provided output directory. The driver gene output file (i.e., driver_genes.xml 411) can contain four main sections: (1) genes with strong evidence to be cancer driver genes; (2) genes with medium evidence to be cancer driver genes; (3) genes with weak evidence to be cancer driver genes; and (4) variants that are not in genes.

The classification of a gene into one of the groups above is done by the driver probability score (e.g., driver probability 250 that the gene drives cancer, see FIG. 2). The score threshold (i.e., the threshold logic) is configurable and can be set by a configuration parameter. For example, genes are classified has having strong driver evidence if: (1) they are ranked at the top two in the driver gene list; or (2) their driver probability score is greater than 0.7 and no more than nine genes are ranked higher in the list. Genes are classified as having medium driver evidence if: (1) they are not in the “strong” list and their driver probability score is greater than 0.4 and no more than nine genes outside of the “strong” list are ranked higher in the list. The threshold logic can take into account the whole gene list (if multiple genes are analyzed) and consider one or more genes in the context of the whole gene list. In other words, the threshold logic considers the interactions between the genes being analyzed. For example, MPA 100 marks the top two genes as having a strong probability to be cancer drivers even if those two genes have low probability scores because those two genes are the highest genes on the list and the assumption is that in each cancer there is at least one driver gene. This example can be considered a mechanism for discovering new knowledge.

In one embodiment, the score threshold can be learnt from the data, e.g., via machine learning and other statistical approaches by analyzing vast amount of patient's ‘omic’ variant information along with insights from cancer genomic experts and/or information from clinical trials and/or information from treatment decisions that oncologists made along with the actual treatment success indicators.

In one embodiment, the present invention can be deployed as a cloud computing based service, or as component of an analytic offering deployed in a cloud computing environment.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows. On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows. Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows. Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

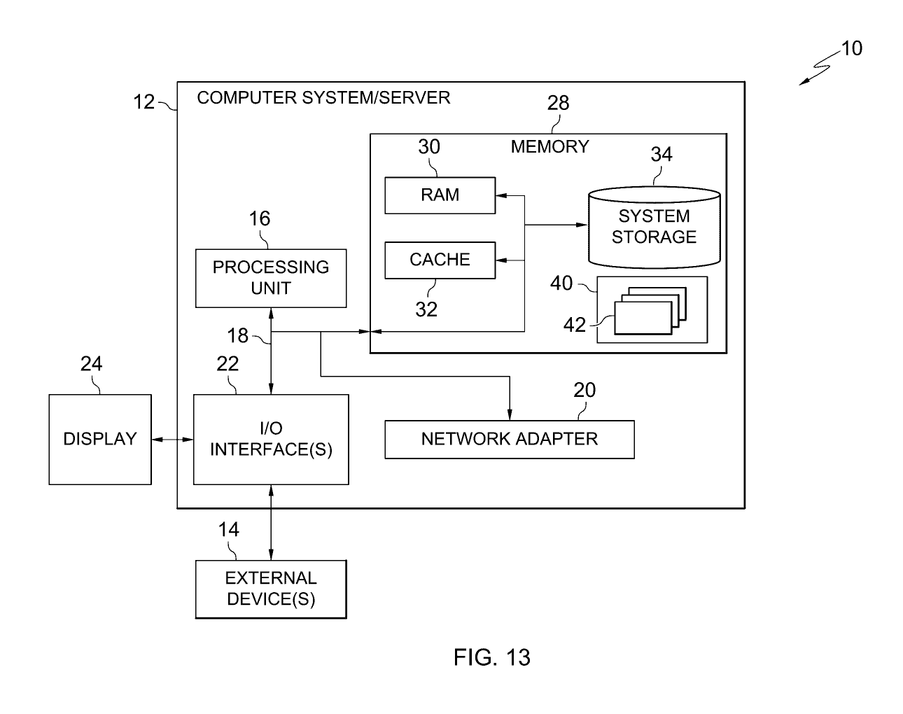

Referring now to FIG. 13, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 13, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

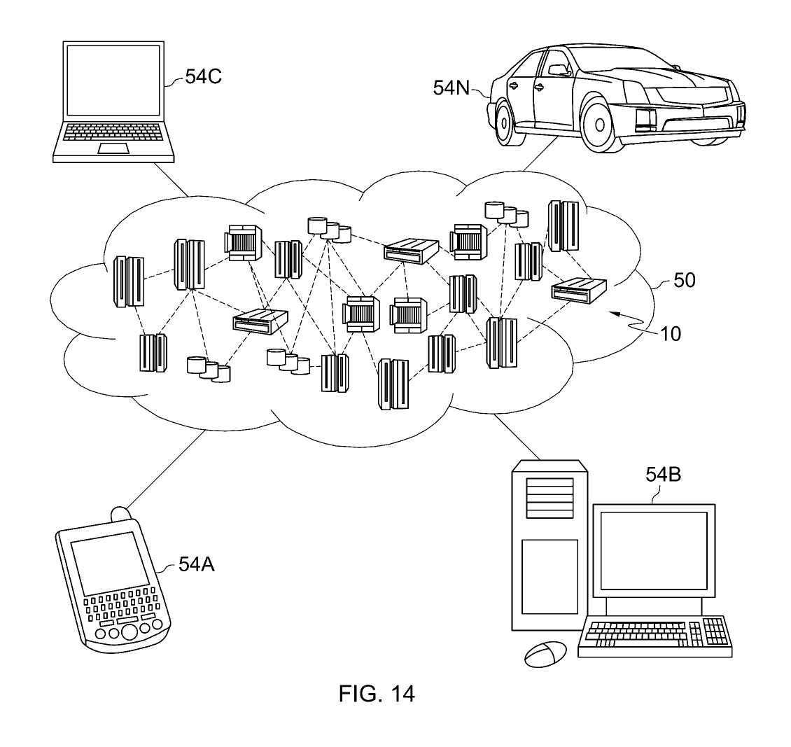

Referring now to FIG. 14, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 14 are intended to be illustrative only and that computing nodes 10 and cloud computing environment 50 can communicate with any type of computerized device over any type of network and/or network addressable connection (e.g., using a web browser).

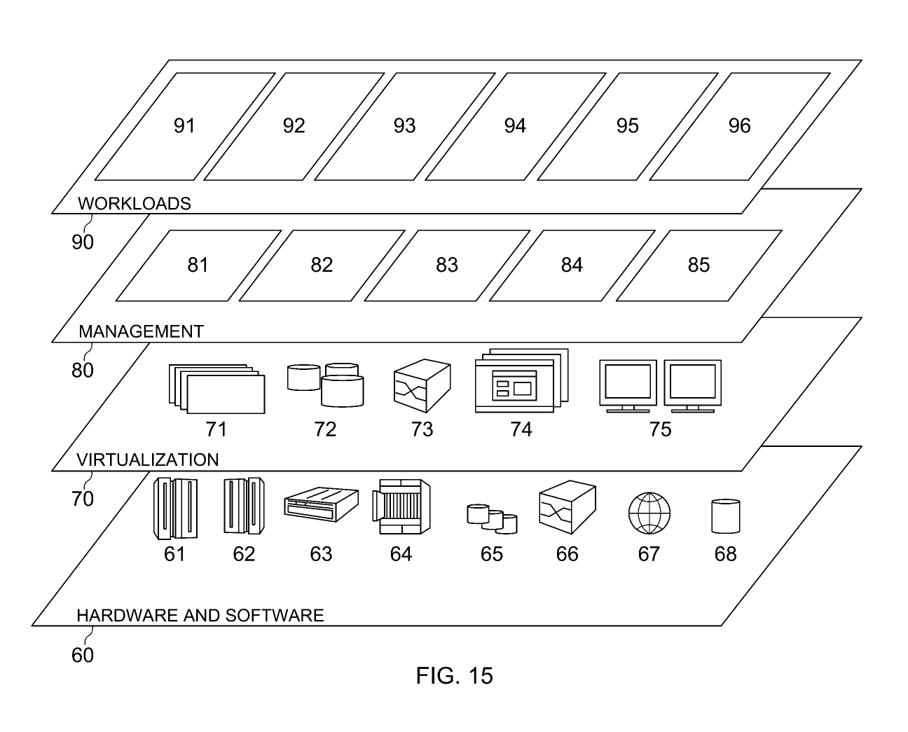

Referring now to FIG. 15, a set of functional abstraction layers provided by cloud computing environment 50 (FIG. 14) is shown. It should be understood in advance that the components, layers, and functions shown in FIG. 15 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and molecular profile analysis processing 96.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for identifying cancer driver genes, the method comprising:
receiving at least one input file for a patient containing information for a gene, wherein the information pertains to at least one of a mutation variation and an expression of the gene;
parsing the information from the at least one input file into a data structure;
annotating the information with cancer driving related annotations; extracting genetic features related to the patient from the information;
scoring the information with at least one of the following:
(i) a first probability that the mutation variation drives cancer, wherein the first probability is calculated with a first Bayesian Network model utilizing the genetic features related to the patient, the cancer driving related annotations, and a first set of weighted probabilities, and
(ii) a set of further probabilities that the expression of the gene drives cancer, wherein the set of further probabilities is calculated with a second Bayesian Network model utilizing the genetic features related to the patient, the cancer driving related annotations, and a second set of weighted probabilities; and
calculating a driver probability that the gene drives cancer, wherein the driver probability is calculated from at least one of the first probability and the set of further probabilities.

2. The method according to claim 1, wherein the first Bayesian Network model comprises:
a first set of nodes listing the genetic features related to the patient;
a second set of nodes listing the cancer driving related annotations; and
a third set of nodes listing the first set of weighted probabilities, and
wherein at least one weighted probability in the first set of weighted probabilities relates to at least one of the genetic features related to the patient,
wherein at least one weighted probability in the first set of weighted probabilities relates to at least one of the cancer driving related annotations, and
wherein the first probability that the mutation variation drives cancer relates to at least one weighted probability in the first set of weighted probabilities and at least one of the genetic features related to the patient.

3. The method according to claim 2, wherein the genetic features related to the patient include at least one of:
a determination of whether the mutation variation is clinically important;
a determination of whether the mutation variation is frequent in cancer;
a determination of whether the mutation variation resides in a region of the gene that is commonly mutated in cancer;
a determination of whether the mutation variation is predicted to be functional;
a determination of whether the mutation variation is a silent mutation; and
a determination of whether the mutation variation is an inactivating mutation.

4. The method according to claim 3, wherein the cancer driving related annotations include at least one of:
a determination of whether the gene is a frequently mutated cancer gene;
a determination of whether the gene is a driver gene due to amplification;
a determination of whether the gene is a driver gene due to deletion;
a determination of whether the gene is an oncogene;
a determination of whether the gene is a tumor suppressor gene;
a determination of whether the gene is a mutation activated oncogene; and
a determination of whether the gene is not classified.

5. The method according to claim 4, wherein the first set of weighted probabilities includes at least one of:
a weighted probability that the mutation variation is clinically validated;
a weighted probability that the mutation variation is frequent in cancer; and
a weighted probability that the mutation variation is functional.

6. The method according to claim 1, wherein the second Bayesian Network model comprises:
a first set of nodes listing the genetic features related to the patient;
a second set of nodes listing the cancer driving related annotations; and
a third set of nodes listing the second set of weighted probabilities, and
wherein at least one weighted probability in the second set of weighted probabilities relates to at least one of the genetic features related to the patient,
wherein at least one weighted probability in the second set of weighted probabilities relates to at least one of the cancer driving related annotations, and
wherein the set of further probabilities that the expression of the gene drives cancer relates to at least one weighted probability in the second set of weighted probabilities and at least one of the genetic features related to the patient.

7. The method according to claim 6, wherein the genetic features related to the patient include at least one of:
a determination of a level of the expression of the gene relative to a first reference gene;
a determination of a level of genomic copies of the gene relative to a second reference gene; and
a determination of whether the gene has an inactivating mutation.

8. The method according to claim 6, wherein the genetic features related to the patient include:
a first determination of a level of the expression of the gene relative to a first reference gene;
a second determination of a level of genomic copies of the gene relative to a second reference gene; and
a third determination of a combined level of the expression of the gene, wherein the third determination is calculated from the first determination and the second determination.

9. The method according to claim 8, wherein the cancer driving related annotations include at least one of:
a determination of whether the gene is a driver gene due to amplification;
a determination of whether the gene is an oncogene;
a determination of whether the gene is a tumor suppressor gene;
a determination of whether the gene is a mutation activated oncogene; and
a determination of whether the gene is not classified.

10. The method according to claim 9, wherein the second set of weighted probabilities include at least one of:
a weighted probability that the expression of the gene drives cancer via a particular mechanism;
a weighted probability that the level of genomic copies drives cancer via a particular mechanism; and
a weighed probability that the combined level of the expression of the gene drives cancer via a particular mechanism.

11. The method according to claim 10, wherein the set of further probabilities includes at least one of:
a probability that the gene is a driver gene due to expression; and
a probability that the gene is a driver gene due to copy number.

12. The method according to claim 1, further comprising an snpEff annotation tool that annotates the information with mutation variation annotations.

13. The method according to claim 1, further comprising an evidence abbreviator that provides supporting rationale and additional justification for at least one of the first probability that the mutation variation drives cancer, the set of further probabilities that the expression of the gene drives cancer, and the driver probability that the gene drives cancer.

14. The method according to claim 1, further comprising a synthetic lethality analysis that identifies pairs of genes that have a functional relationship that can be targeted leading to cell death.

15. The method according to claim 1, wherein the scoring the information comprises scoring the information with the first probability that the mutation variation drives cancer, wherein the first probability is calculated with the first Bayesian Network model utilizing the genetic features related to the patient, the cancer driving related annotations, and the first set of weighted probabilities.

16. The method according to claim 1, wherein the scoring the information comprises scoring the information with the set of further probabilities that the expression of the gene drives cancer, wherein the set of further probabilities is calculated with the second Bayesian Network model utilizing the genetic features related to the patient, the cancer driving related annotations, and the second set of weighted probabilities.

17. The method according to claim 1, wherein the at least one input file contains information for multiple genes, and further comprising:
outputting an output file containing a ranked list of cancer driver genes, supporting rationale, and additional justification for at least one of the first probability that the mutation variation drives cancer, the set of further probabilities that the expression of the gene drives cancer, and the driver probability that the gene drives cancer.

18. The method according to claim 1, wherein the information further pertains to a molecular marker for a variant of the gene, and further comprising:
scoring the information with a probability that the molecular marker for a variant of the gene drives cancer, and
wherein the calculating the driver probability that the gene drives cancer includes the probability that the molecular marker for a variant of the gene drives cancer.

19. A computer system for identifying cancer driver genes, the computer system comprising at least one processor, at least one computer readable memory, at least one computer readable tangible, non-transitory storage medium, and program instructions stored on the at least one computer readable tangible, non-transitory storage medium for execution by the at least one processor via the at least one computer readable memory, wherein the program instructions comprise program instructions for:
receiving at least one input file for a patient containing information for a gene, wherein the information pertains to at least one of a mutation variation and an expression of the gene;
parsing the information from the at least one input file into a data structure;
annotating the information with cancer driving related annotations;
extracting genetic features related to the patient from the information;
scoring the information with at least one of the following:
(i) a first probability that the mutation variation drives cancer, wherein the first probability is calculated with a first Bayesian Network model utilizing the genetic features related to the patient, the cancer driving related annotations, and a first set of weighted probabilities, and
(ii) a set of further probabilities that the expression of the gene drives cancer, wherein the set of further probabilities is calculated with a second Bayesian Network model utilizing the genetic features related to the patient, the cancer driving related annotations, and a second set of weighted probabilities; and
calculating a driver probability that the gene drives cancer, wherein the driver probability is calculated from at least one of the first probability and the set of further probabilities.

20. A computer program product identifying cancer driver genes, the computer program product comprising at least one computer readable non-transitory storage medium having computer readable program instructions thereon for execution by a processor, the computer readable program instructions comprising program instructions for:
receiving at least one input file for a patient containing information for a gene, wherein the information pertains to at least one of a mutation variation and an expression of the gene;
parsing the information from the at least one input file into a data structure;
annotating the information with cancer driving related annotations;
extracting genetic features related to the patient from the information;
scoring the information with at least one of the following:
(i) a first probability that the mutation variation drives cancer, wherein the first probability is calculated with a first Bayesian Network model utilizing the genetic features related to the patient, the cancer driving related annotations, and a first set of weighted probabilities, and
(ii) a set of further probabilities that the expression of the gene drives cancer, wherein the set of further probabilities is calculated with a second Bayesian Network model utilizing the genetic features related to the patient, the cancer driving related annotations, and a second set of weighted probabilities; and
calculating a driver probability that the gene drives cancer, wherein the driver probability is calculated from at least one of the first probability and the set of further probabilities.
